(19) United States
(12) Patent Application Publication
(10) Pub. No.: US 2025/0165675 A1
(43) Pub. Date: May 22, 2025

(54) OPTIMIZATION METHOD FOR MOLDING MOLD AND FILLING PROCESS OF RESIN TRANSFER MOLDING (RTM) TO FORM FIBER FABRIC REINFORCED RESIN-BASED COMPOSITE PARTS

(71) Applicants: NORTH UNIVERSITY OF CHINA, Taiyuan (CN); SHANXI ZHONGBEI NEW MATERIAL TECHNOLOGY CO., LTD., Taiyuan (CN)

(72) Inventors: Yaqing LIU, Taiyuan (CN); Qihui CHEN, Taiyuan (CN); Guizhe ZHAO, Taiyuan (CN)

(21) Appl. No.: 19/034,139

(22) Filed: Jan. 22, 2025

(30) Foreign Application Priority Data
Jun. 12, 2024 (CN) 202410750333.X

(51) Int. Cl. G06F 30/23; B29C 70/48; B29C 70/54; B29K 63/00; B29K 223/00

(52) U.S. Cl. CPC G06F 30/23; B29C 70/48; B29C 70/54; B29K 2063/00; B29K 2223/06

(57) ABSTRACT

An optimization method for molding mold and filling process of resin transfer molding (RTM) to form fiber fabric reinforced resin-based composite parts is provided. A simulation platform is used to simulate the mold filling process of RTM process. Brinkman equations are used to describe a flow of resin in fiber fabric. Numbers and positions, process parameters and material parameters of an injection gate and a discharging gate of the molding mold are set, and then the mold filling process is simulated. Darcy's law is utilized to determine a required time and a mold filling effect of the mold filling with the resin. Finally, a molding mold structure and the filling process of RTM to form fiber fabric reinforced resin-based composite part with high production efficiency and good quality are obtained.

### CROSS-REFERENCE TO RELATED APPLICATIONS

This application claims the benefit of priority from Chinese Patent Application No. 202410750333.X, filed on Jun. 12, 2024. The content of the aforementioned application, including any intervening amendments thereto, is incorporated herein by reference in its entirety.

### TECHNICAL FIELD

This application relates to molding of fiber fabric reinforced resin-based composite parts, and more particularly to an optimization method for molding mold and filling process of resin transfer molding (RTM) to form high-quality parts made of fiber fabric reinforced resin-based composites.

### BACKGROUND

With technology evolving rapidly, demand for materials is no longer confined to single materials. Composites offer a wide range of advantages over single materials, such as higher specific strength and specific modulus, light weight, and corrosion resistance. Due to these, composites have received increasing attention and extensive research worldwide. Along various aspects, the optimization of molding process becomes the focus.

There are many manufacturing methods for products made from fiber fabric reinforced resin-based composites, among which resin transfer molding (RTM) is one of the most concerned processes. RTM technique has various advantages. Products manufactured by the RTM technique feature stable dimensions and smooth surfaces, and as a result, the post-processing for the products can be reduced. It is possible to place reinforcing fibers within the products according to their stress conditions, and volume fractions of the reinforcing fibers can be adjusted by controlling the pressure during filling, reaching up to 65%. These result in the products with excellent performance. RTM, a closed-mold forming method, generates less pollution and is more environmentally friendly. In summary, RTM is outstanding for molding fiber fabric reinforced resin-based composite products or parts, which has been widely studied and applied both at home and abroad.

However, RTM process does have some disadvantages, such as dry spots and resin shortage in formed parts. The RTM process involves two stages: mold filling and curing. During the mold filling stage, it is difficult to observe a flow of resin within a mold cavity, so different mold filling schemes need to be designed. These schemes include the number and position of resin inlets and resin outlets of the mold, as well as injection process parameters such as injection pressure or vacuum pressure. Only after evaluating the quality of the molded parts according to different schemes can the molding mold structure and the mold filling process be finally determined. However, optimizing the molding mold structure and the mold filling schemes solely through experimental methods not only takes a great deal of time but also consumes large amounts of materials and energy. Therefore, it is of great significance to provide an efficient optimization method for the molding mold structures and the mold filling schemes.

As computer technology races forward, using finite element simulation to replace traditional experimental operations has been widely concerned and applied. A finite element software is used to simulate the mold filling flow during the RTM of the fiber fabric reinforced resin-based composites, predicting a molding time of a part and a mold filling pressure on each part of the product to assist in the design of mold filling scheme, which greatly improve the design efficiency. Consequently, it not only enhances the production efficiency of high-performance composite parts formed by RTM but also save a substantial amount of manpower, material resources, and financial resources. This plays a crucial role in promoting the application of the fiber fabric reinforced resin-based composite parts.

### SUMMARY

In order to address the deficiencies of existing RTM molding, which are prone to dry spots and insufficient resin in formed parts, this application provides an optimization method for molding mold and filling process of resin transfer molding (RTM) to form high-quality parts made of fiber fabric reinforced resin-based composites.

Technical solutions of this application are described as follows.

An optimization method for molding mold and filling process of resin transfer molding (RTM) to form fiber fabric reinforced resin-based composite parts, comprising:
(S1) using a model wizard in a simulation platform, choosing Brinkman equations in a fluid flow level set and selecting a Transient state with a phase initialization in a multi-physics preset to complete a selection of the model wizard;
(S2) setting up a model according to a geometry of the parts by using a Component in a Model Builder window of the simulation platform;
(S3) creating two empty materials under a node of the Component in the Model Builder window, wherein one of the two empty materials is assigned with a performance parameter of air and designated as an Empty Material 1, and the other one of the two empty materials is assigned with a performance parameter of a resin system and designated as an Empty Material 2;
(S4) selecting a Porous Material under the Component node and entering values of a porosity εₚ of a fiber fabric and a permeability k of the fiber fabric in a setting of the porous material;
(S5) selecting the Brinkman equations under the Component node and choosing a Porous Slip in a Locating Physical Model column of the Brinkman equations;
(S6) designing a resin system injection port and a resin system discharge port on a surface of the constructed model; setting the resin system injection port as an inlet and the resin system discharge port as an outlet respectively, and positioning the inlet and the outlet in a boundary condition column; selecting a driving mode as a pressure, and entering a value of the pressure of a RTM molding injection pressure or a vacuum negative pressure;
(S7) selecting the constructed model and performing a grid division, choosing a Free Triangular mesh as a grid type and clicking on Build All to complete the grid division of the model;
(S8) in the Model Developer window, clicking on a function key Study 1, then clicking on a sub function key Solver Configuration of the Study 1, then clicking on a sub function key Solution 1 of the Solver Configuration, then clicking on a sub function key Transient Solver 1 Node of the Solution 1; setting a stop condition for simulation under the Transient Solver 1 node as a stop expression and inputting the stop expression; and
(S9) running a mold filling program with the resin system of the Empty Material 2 into a molding mold covered with the fiber fabric to simulate the mold filling process; and determining a stimulated time of the mold filling with the resin system and a stimulated effect of the mold filling with the resin system according to Darcy's law, obtaining the molding mold structure and the filling process of RTM to form the fiber fabric reinforced resin-based composite part.

In an embodiment, in step (S1), the Brinkman equations are expressed as:

$$\frac{ρ}{{ε}_{p}} \frac{\partial u}{\partial t} = ∇ \cdot [ - pI + \frac{μ}{{ε}_{p}} ( ∇ u + {( ∇ u )}^{T} ) ] - ( \frac{μ}{k} + βρ \vert u \vert ) u ; and$$

$$ρ ∇ \cdot u = 0 ;$$

wherein μ represents a dynamic viscosity of the resin system of the Empty Material 2; u represents an injection velocity vector; ρ represents a density of the resin system of the Empty Material 2; p represents the injection pressure or the vacuum negative pressure; I represents a unit tensor; T represents a temperature of the resin system of the Empty Material 2; β represents a thermal expansion coefficient of the resin system of the Empty Material 2; and t represents a mold filling time.

In an embodiment, in step (S9), during the mold filling process with the resin system of the Empty Material 2, the air of the Empty Material 1 in the mold is discharged through a calculation method of a two-phase flow level set.

In an embodiment, the two-phase flow level set is solved through an equation of a level set function describing an interface of two phases, expressed as:

$${ε}_{p} \frac{\partial ϕ}{\partial t} + u \cdot ∇ ϕ = ∇ \cdot ( {ε}_{ls} ∇ ϕ - ϕ ( 1 - ϕ ) \frac{∇ ϕ}{\vert ∇ ϕ \vert} ) ;$$

wherein ϕ represents the level set function that is 0 in one of the two phases and 1 in the other one of the two phases; εₚ represents the porosity of the fiber fabric; εₗₛ represents a thickness of the interface of the two phases.

In an embodiment, in step (S4), in order to improve a simulation efficiency, the permeability of the fiber fabric is processed by a simplified model, and an equivalent permeability is adopted as the permeability k of the fiber fabric.

In an embodiment, the equivalent permeability is calculated through a formula, expressed as:

$${K}_{e} = \frac{{\sum }_{i = 1}^{n} {K}_{i} {H}_{i}}{{\sum }_{i = 1}^{n} {H}_{i}} = \frac{{K}_{1} {H}_{1} + {K}_{2} {H}_{2} + … + {K}_{n} {H}_{n}}{H} ;$$

wherein n represents a total number of layers of the fiber fabric; Hᵢ represents a thickness of each of the layers of the fiber fabric; Kᵢ represents a permeability of each of the layers of the fiber fabric; i are 1, 2, . . . , n; H represents a total thickness of all layers of the fiber fabric; and Kₑ represents the equivalent permeability of the fiber fabric.

In an embodiment, the dynamic viscosity μ of the resin system is 0.1˜0.3 Pa·s.

In an embodiment, the permeability k of the fiber fabric is 0.614-4.127×10⁻¹⁰ m².

Compared to the prior art, the present disclosure has the following beneficial effects.

This application enables the prediction of the molding mold filling times and the filling effects associated with various molding mold design schemes and filling process parameters in the RTM process, thereby effectively shortening the design cycle of the RTM molding mold structure and the determination cycle of the mold filling process, and ultimately leading to a substantial improvement in the production efficiency and the part quality of fiber fabric reinforced resin-based composite parts form by the RTM process.

### BRIEF DESCRIPTION OF THE DRAWINGS

The accompanying drawings herein are incorporated into the specification and form a part of the specification, showing embodiments consistent with the present disclosure, and illustrating the principle of the present disclosure together with the specification.

In order to illustrate the technical solutions of this application or the prior art more clearly, the accompanying drawings required in the description of embodiments or the prior art will be briefly introduced below. It is obvious that for those of ordinary skill in the art, other relevant accompanying drawings can also be obtained according to these drawings without making creative effort.

FIG. 1 is a simplified schematic diagram of a molding mold of resin transfer molding (RTM) to form a high-quality flat board made of an ultra-high-molecule-weight polyethylene fiber fabric reinforced epoxy resin-based composites according to an embodiment of the present disclosure.

FIG. 2 is a process diagram for simplifying and optimizing a molding mold and a mold filling process of RTM to form the high-quality flat board made of the ultra-high molecular weight polyethylene fiber fabric reinforced epoxy resin matrix composite according to an embodiment of the present disclosure.

FIG. 3 shows a simulation result of the RMT mold filling process at 6 min for a high-quality flat board made of the ultra-high molecular weight polyethylene fiber fabric reinforced epoxy resin matrix composite according to an embodiment of the present disclosure.

FIG. 4 is a comparison diagram between a simulated mold filling process and an experimental mold filling process of RTM for forming the high-quality flat board made of the ultra-high molecular weight polyethylene fiber fabric reinforced epoxy resin matrix composite according to an embodiment of the present disclosure.

FIG. 5 is a simplified design diagram of a RTM molding mold of a high-quality curved part made of the ultra-high molecular weight polyethylene fiber fabric reinforced epoxy resin matrix composite according to an embodiment of the present disclosure.

FIG. 6 is a process diagram for simplifying and optimizing a molding mold and a mold filling process of RTM to form the high-quality curved part made of the ultra-high molecular weight polyethylene fiber fabric reinforced epoxy resin matrix composite according to an embodiment of the present disclosure.

FIG. 7 shows a simulation result of the RMT mold filling process at 11 min for the high-quality curved part made of the ultra-high molecular weight polyethylene fiber fabric reinforced epoxy resin matrix composite material according to an embodiment of the present disclosure.

### DETAILED DESCRIPTION OF EMBODIMENTS

To make the above object, features and advantages of the present disclosure more clearly, the present disclosure will be further described below with reference to the accompanying drawings and the specific embodiments. It should be noted that embodiments of the present disclosure and features in the embodiments can be combined with each other without conflict.

Many specific details are set forth in the description below to facilitate a complete understanding of the present disclosure, however, the present disclosure can be implemented in other ways different from that described herein. It is obvious that the embodiments in the specification are only part of embodiments of this application, rather than all of the embodiments.

Specific embodiments of this application are described in detail below.

### Embodiment 1

This embodiment provides an optimization method for molding mold and filling process of resin transfer molding (RTM) to form a high-quality flat board made of an ultra-high molecular weight polyethylene fiber fabric reinforced E-51 epoxy resin matrix composite, including the following steps.

(S1) The model wizard in Comsol was used, and Brinkman equations were selected in the fluid flow level set. The transient state with the phase initialization was selected in the multi-physics preset to complete the selection of the Comsol model wizard.

In step (S1), the Brinkman equations were expressed as:

$$\frac{ρ}{{ε}_{p}} \frac{\partial u}{\partial t} = ∇ \cdot [ - pI + \frac{μ}{{ε}_{p}} ( ∇ u + {( ∇ u )}^{T} ) ] - ( \frac{μ}{k} + βρ \vert u \vert ) u ;$$

$$ρ ∇ \cdot u = 0 ;$$

where μ represents the dynamic viscosity of the E-51 epoxy resin system; u represents the injection velocity vector; ρ represents the density of the E-51 epoxy resin system; p represents the injection pressure; εₚ represents the porosity of the ultra-high molecular weight polyethylene fiber fabric; k represents the permeability of the ultra-high molecular weight polyethylene fiber fabric; I represents a unit tensor; T represents the temperature of the E-51 epoxy resin system; β represents the thermal expansion coefficient of the E-51 epoxy resin system; and t represents the mold filling time.

(S2) The Component in the Comsol Model Builder window was used. According to the geometry of the flat board, the model was established. The flat board of this embodiment was made of the ultra-high molecular weight polyethylene fiber fabric reinforced E-51 epoxy resin-based composite and had a size of 25×25×0.4 cm.

(S3) Two empty materials were established under the node of the Component in the Comsol Model Builder window, where one of the two empty materials was assigned with the performance parameter of the air with the density of 1 kg/m³ and the viscosity of 1×10⁻⁵ Pa's and designated as the Empty Material 1, while the other one of the two empty materials was assigned with the performance parameter of the E-51 epoxy resin system with the density of 1280 kg/m³ and the viscosity of 0.2 Pas and designated as the Empty Material 2.

(S4) The Porous Material under the Component node was selected and the values of the ultra-high molecular weight polyethylene fiber fabric are input in the setting of the porous material, where the porosity εₚ is 43.75%, and the permeability k is 2.4×10⁻¹¹ m².

(S5) The fluid flow in the porous material was the two-phase flow, where the two-phase flow level set was solved through the equation of the level set function describing the interface of the two phases, expressed as:

$${ε}_{p} \frac{\partial ϕ}{\partial t} + u \cdot ∇ ϕ = ∇ \cdot ( {ε}_{ls} ∇ ϕ - ϕ ( 1 - ϕ ) \frac{∇ ϕ}{\vert ∇ ϕ \vert} ) ;$$

where ϕ represents the level set function that is 0 in one of the two phases and 1 in the other one of the two phases; εₚ represents the porosity of the ultra-high molecular weight polyethylene fiber fabric; εₗₛ represents the thickness of the interface of the two phases.

(S6) The Brinkman equations were selected under the Component node and the Porous Slip was selected in the Locating Physical Model column of the Brinkman equations.

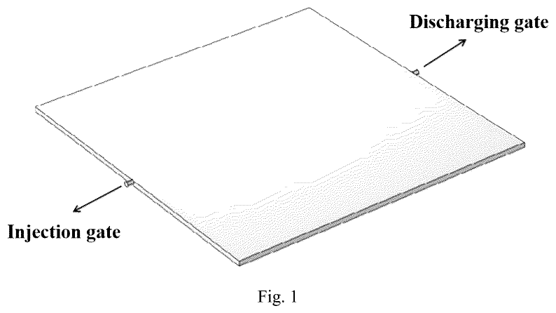

(S7) The resin system injection port and the resin system discharge port on the surface of the constructed model were designed, where the design diagram is shown in FIG. 1. The resin system injection port was set as the inlet, and the resin system discharge port was set as the outlet, and the inlet and the outlet are positioned in the boundary condition column. The driving mode of pressure was selected. The value of the injection pressure of RTM forming is 800 kPa.

(S8) The constructed flat board model was selected, followed by grid division. The Free Triangular mesh was selected as the grid type of the grid division. Build All was clicked to complete the grid division of the model.

(S9) In the Model Developer window, the function key Study 1 was clicked on, then the sub function key Solver Configuration of the Study 1 was clicked on, then the sub function key Solution 1 of the Solver Configuration was clicked on, then the sub function key Transient Solver 1 Node of the Solution 1 was clicked on. The stop condition for simulation under the Transient Solver 1 node was set as the stop expression and the stop expression was inputted.

(S10) The mold filling program with the E-51 epoxy resin system into the molding mold covered with the ultra-high molecular weight polyethylene fiber fabric was run to simulate the mold filling process. The stimulated time of the mold filling with the E-51 epoxy resin system and the stimulated mold filling effect of the E-51 epoxy resin were determined according to Darcy's law. The molding mold structure and the filling process of RTM to form the high-quality flat board made of the ultra-high molecular weight polyethylene fiber fabric reinforced E-51 epoxy resin-based composite were obtained.

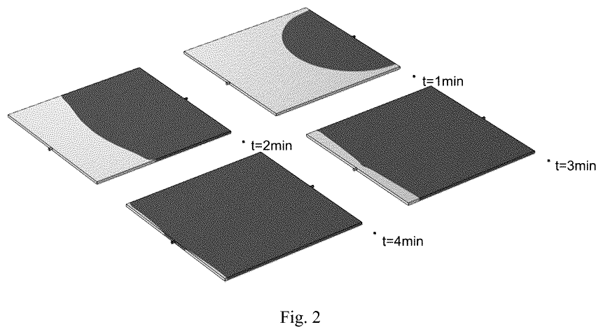

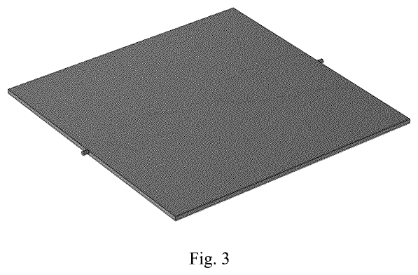

FIG. 2 is a process diagram for simplifying and optimizing the molding mold and the mold filling process of RTM to form the high-quality flat board made of the ultra-high molecular weight polyethylene fiber fabric reinforced epoxy resin matrix composite. FIG. 2 shows the optimized mold structure and filling process for the RTM of this flat board. The figure displays the simulation results of the mold filling time and corresponding mold filling percentage (a percentage of a mold filling area in a total area of the part) of E-51 epoxy resin in the ultra-high molecular weight polyethylene fiber fabric. It can be seen from the simulation results in FIG. 2 that, according to this mold filling scheme, when the mold filling is performed for 1 min, the mold filling percentage is 30%; when the mold filling is performed for 2 min, the mold filling percentage is 60%; when the mold filling is performed for 6 min, the mold filling percentage is 100%. In the combination of FIG. 3, when the mold filling is performed for 6 min, the ultra-high molecular weight polyethylene fiber fabric is completely impregnated, indicating a good effect of mold filling, that is, the mold filling process is completed. Therefore, the mold structure and the parameters of mold filling process of RTM forming of the high-quality flat board made of the ultra-high molecular weight polyethylene fiber fabric reinforced E-51 epoxy resin matrix composite are obtained.

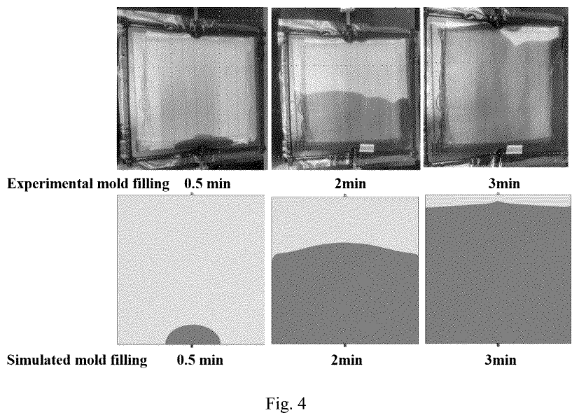

FIG. 4 is a comparison diagram between a simulated mold filling process and an experimental mold filling process of RTM for forming of the flat board. FIG. 4 shows the comparison of the mold filling results when the simulated mold filling and the experimental mold filling are carried out to 0.5 min, 2 min, and 3 min respectively. It can be found from the comparison diagram that when the mold filling process is performed for 0.5 min, the E-51 epoxy resin begins to impregnate the ultra-high molecular weight polyethylene fiber fabric from the resin injection port. A front edge of the resin in the experimental mold filling is irregularly semi-circular, while the simulated mold filling has a more idealized filling environment, and a front edge of the resin in the simulated mold filling is semi-circular and is more regular than that of the experimental mold filling. With the processes of mold fillings, although the shapes of the front edges of the resin in the experimental mold filling and the simulated mold filling are different at 2 min and 3 min of resin mold fillings, the percentages of resin impregnation and the areas of mold filling at each stage are in good agreement.

### Embodiment 2

This embodiment provides an optimization method for molding mold and filling process of RTM to form a high-quality curved part made of an ultra-high molecular weight polyethylene fiber fabric reinforced E-51 epoxy resin matrix composite, including the following steps.

(S1) The model wizard in Comsol was used, and Brinkman equations were selected in the fluid flow level set. The transient state with the phase initialization was selected in the multi-physics preset to complete the selection of the Comsol model wizard.

In step (S1), the Brinkman equations were expressed as:

$$\frac{ρ}{{ε}_{p}} \frac{\partial u}{\partial t} = ∇ \cdot [ - pI + \frac{μ}{{ε}_{p}} ( ∇ u + {( ∇ u )}^{T} ) ] - ( \frac{μ}{k} + βρ \vert u \vert ) u ;$$

$$ρ ∇ \cdot u = 0 ;$$

where μ represents the dynamic viscosity of the E-51 epoxy resin system; u represents the injection velocity vector; ρ represents the density of the E-51 epoxy resin system; p represents the injection pressure; εₚ represents the porosity of the ultra-high molecular weight polyethylene fiber fabric; k represents the permeability of the ultra-high molecular weight polyethylene fiber fabric; I represents a unit tensor; T represents the temperature of the E-51 epoxy resin system; β represents the thermal expansion coefficient of the E-51 epoxy resin system; and t represents the mold filling time.

(S2) The Component in the Comsol Model Builder window was used.

According to the geometry of the curved part, the model was established. The curved part of this embodiment was made of the ultra-high molecular weight polyethylene fiber fabric reinforced E-51 epoxy resin-based composite and had a structure with the upper base radius of 13 cm, the height of 6 cm, the thickness of 0.4 cm and the chamfer of 0.5 mm.

(S3) Two empty materials were established under the node of the Component in the Comsol Model Builder window, where one of the two empty materials assigning the performance parameter of the air with the density of 1 kg/m³ and the viscosity of 1×10⁻⁵ Pa's and designating as the Empty Material 1, while the other one of the two empty materials assigning the performance parameter of the E-51 epoxy resin system with the density of 1280 kg/m³ and the viscosity of 0.2 Pa's and designating as the Empty Material 2.

(S4) The Porous Material under the Component node was selected and the values of the ultra-high molecular weight polyethylene fiber fabric are input in the setting of the porous material, where the porosity εₚ is 43.75%, and the permeability k is 2.4×10⁻¹¹ m².

(S5) The fluid flow in the porous material was the two-phase flow, where the two-phase flow level set was solved through the equation of the level set function describing the interface of the two phases, expressed as:

$${ε}_{p} \frac{\partial ϕ}{\partial t} + u \cdot ∇ ϕ = ∇ \cdot ( {ε}_{ls} ∇ ϕ - ϕ ( 1 - ϕ ) \frac{∇ ϕ}{\vert ∇ ϕ \vert} ) ;$$

where ϕ represents the level set function that is 0 in one of the two phases and 1 in the other one of the two phases; εₚ represents the porosity of the ultra-high molecular weight polyethylene fiber fabric; εₗₛ represents the thickness of the interface of the two phases.

(S6) The Brinkman equations were selected under the Component node and the Porous Slip was selected in the Locating Physical Model column of the Brinkman equations.

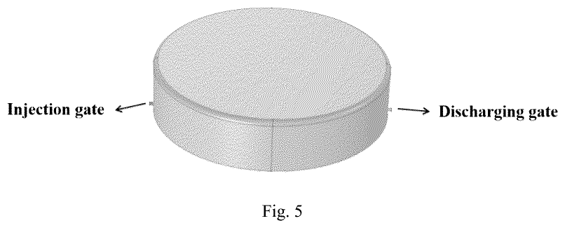

(S7) The resin system injection port and the resin system discharge port on the surface of the constructed model were designed, where the design diagram is shown in FIG. 5. The resin system injection port was set as the inlet, and the resin system discharge port was set as the outlet, and the inlet and the outlet are positioned in the boundary condition column. The driving mode of pressure was selected. The value of the injection pressure of RTM forming is 800 kPa.

(S8) The constructed model was selected, followed by grid division. The Free Triangular mesh was selected as the grid type of the grid division. Build All was clicked to complete the grid division of the model.

(S9) In the Model Developer window, the function key Study 1 was clicked on, then the sub function key Solver Configuration of the Study 1 was clicked on, then the sub function key Solution 1 of the Solver Configuration was clicked on, then the sub function key Transient Solver 1 Node of the Solution 1 was clicked on. The stop condition for simulation under the Transient Solver 1 node was set as the stop expression and the stop expression was inputted.

(S10) The mold filling program with the E-51 epoxy resin system into the molding mold covered with the ultra-high molecular weight polyethylene fiber fabric was run to simulate the mold filling process. The stimulated time of the mold filling with the E-51 epoxy resin system and the stimulated mold filling effect of the E-51 epoxy resin were determined according to Darcy's law. The molding mold structure and the filling process of RTM to form the high-quality curved part made of the ultra-high molecular weight polyethylene fiber fabric reinforced E-51 epoxy resin-based composite were obtained.

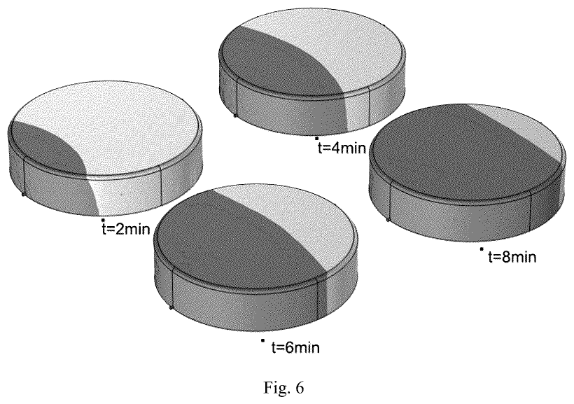

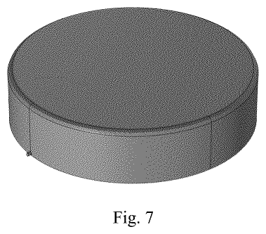

FIG. 6 is a process diagram for simplifying and optimizing the molding mold and the mold filling process of RTM to form the curved part. FIG. 6 shows the simulation results of the mold filling time and corresponding mold filling percentage (the percentage of the mold filling area in the total area of the part) of E-51 epoxy resin in the ultra-high molecular weight polyethylene fiber fabric. It can be seen from the simulation results in FIG. 6 that, according to this mold filling scheme, when the mold filling is performed for 2 min, the mold filling percentage is 20%; when the mold filling is performed for 4 min, the mold filling percentage is 40%; when the mold filling is performed for 6 min, the mold filling percentage is 40%; when the mold filling is performed for 8 min, the mold filling percentage is 80%. Referring to FIG. 7, when the mold filling is performed for 11 min, the ultra-high molecular weight polyethylene fiber fabric is completely impregnated, indicating a good effect of mold filling, that is, the mold filling process is completed. Therefore, the mold structure and the parameters of mold filling process of RTM forming of the high-quality curved part made of the ultra-high molecular weight polyethylene fiber fabric reinforced E-51 epoxy resin matrix composite are obtained.

Described above are specific embodiments of the present disclosure, which are intended to enable those of ordinary skill in the art to understand or implement the present disclosure, rather than limiting the disclosure. Although the disclosure has been are described in detail with reference to the above embodiments, it should be understood by those of ordinary skill in the art that modifications and equivalent replacements can still be made to some or all of the technical features recited in the above embodiments. Such modifications and replacements made without departing from the scope of the present disclosure shall fall within the scope of this application defined by the appended claims.

What is claimed is:

1. An optimization method for molding mold and filling process of resin transfer molding (RTM) to form fiber fabric reinforced resin-based composite parts, comprising:
(S1) using a model wizard in a simulation platform, choosing Brinkman equations in a fluid flow level set and selecting a Transient state with a phase initialization in a multi-physics preset to complete a selection of the model wizard;
(S2) setting up a model according to a geometry of the parts by using a Component in a Model Builder window of the simulation platform;
(S3) creating two empty materials under a node of the Component in the Model Builder window, wherein one of the two empty materials is assigned with a performance parameter of air and designated as an Empty Material 1, and the other one of the two empty materials is assigned with a performance parameter of a resin system and designated as an Empty Material 2;
(S4) selecting a Porous Material under the Component node and entering values of a porosity εₚ of a fiber fabric and a permeability k of the fiber fabric in a setting of the porous material;
(S5) selecting the Brinkman equations under the Component node and choosing a Porous Slip in a Locating Physical Model column of the Brinkman equations;
(S6) designing a resin system injection port and a resin system discharge port on a surface of the constructed model; setting the resin system injection port as an inlet and the resin system discharge port as an outlet respectively, and positioning the inlet and the outlet in a boundary condition column; selecting a driving mode as a pressure, and entering a value of the pressure of an RTM molding injection pressure or a vacuum negative pressure;
(S7) selecting the constructed model and performing a grid division, choosing a Free Triangular mesh as a grid type and clicking on Build All to complete the grid division of the model;
(S8) in the Model Developer window, clicking on a function key Study 1, then clicking on a sub function key Solver Configuration of the Study 1, then clicking on a sub function key Solution 1 of the Solver Configuration, then clicking on a sub function key Transient Solver 1 Node of the Solution 1; setting a stop condition for simulation under the Transient Solver 1 node as a stop expression and inputting the stop expression;
(S9) running a mold filling program with the resin system of the Empty Material 2 into a molding mold covered with the fiber fabric to simulate the mold filling process; and determining a stimulated time of the mold filling with the resin system and a stimulated effect of the mold filling with the resin system according to Darcy's law, obtaining the molding mold structure and the filling process of RTM to form the fiber fabric reinforced resin-based composite part.

2. The method of claim 1, wherein in step (S1), the Brinkman equations are expressed as:
$$\frac{ρ}{{ε}_{p}} \frac{\partial u}{\partial t} = ∇ \cdot [ - pI + \frac{μ}{{ε}_{p}} ( ∇ u + {( ∇ u )}^{T} ) ] - ( \frac{μ}{k} + βρ \vert u \vert ) u ; and$$
$$ρ ∇ \cdot u = 0 ;$$
wherein μ represents a dynamic viscosity of the resin system of the Empty Material 2; u represents an injection velocity vector; ρ represents a density of the resin system of the Empty Material 2; p represents the injection pressure or the vacuum negative pressure; I represents a unit tensor; T represents a temperature of the resin system of the Empty Material 2; β represents a thermal expansion coefficient of the resin system of the Empty Material 2; and t represents a mold filling time.

3. The method of claim 1, wherein in step (S9), during the mold filling process with the resin system of the Empty Material 2, the air of the Empty Material 1 in the mold is discharged through a calculation method of a two-phase flow level set.

4. The method of claim 3, wherein the two-phase flow level set is solved through an equation of a level set function describing an interface of two phases, expressed as:
$${ε}_{p} \frac{\partial ϕ}{\partial t} + u \cdot ∇ ϕ = ∇ \cdot ( {ε}_{ls} ∇ ϕ - ϕ ( 1 - ϕ ) \frac{∇ ϕ}{\vert ∇ ϕ \vert} ) ;$$
wherein ϕ represents the level set function that is 0 in one of the two phases and 1 in the other one of the two phases; εₚ represents the porosity of the fiber fabric; εₗₛ represents a thickness of the interface of the two phases.

5. The method of claim 1, wherein in step (S4), in order to improve a simulation efficiency, the permeability of the fiber fabric is processed by a simplified model, and an equivalent permeability is adopted as the permeability k of the fiber fabric.

6. The method of claim 5, wherein the equivalent permeability is calculated through a formula, expressed as:
$${K}_{e} = \frac{{\sum }_{i = 1}^{n} {K}_{i} {H}_{i}}{{\sum }_{i = 1}^{n} {H}_{i}} = \frac{{K}_{1} {H}_{1} + {K}_{2} {H}_{2} + … + {K}_{n} {H}_{n}}{H} ;$$
wherein n represents a total number of layers of the fiber fabric; Hᵢ represents a thickness of each of the layers of the fiber fabric; Kᵢ represents a permeability of each of the layers of the fiber fabric; i is 1, 2, . . . , n; H represents a total thickness of all layers of the fiber fabric; and Kₑ represents the equivalent permeability of the fiber fabric.

7. The method of claim 2, wherein the dynamic viscosity μ of the resin system is 0.1˜0.3 Pa·s.

8. The method of claim 2, wherein the permeability k of the fiber fabric is 0.614-4.127×10⁻¹⁰ m².
